(19) United States
(12) Patent Application Publication
(10) Pub. No.: US 2024/0114161 A1
(43) Pub. Date: Apr. 4, 2024

(54) ADAPTIVE RESOLUTION MANAGEMENT USING SUB-FRAMES

(71) Applicant: OP Solutions, LLC, Amherst, MA (US)

(72) Inventors: Borivoje Furht, Boca Raton, FL (US); Hari Kalva, Boca Raton, FL (US); Velibor Adzic, Canton, GA (US)

(73) Assignee: OP Solutions, LLC, Amherst, MA (US)

(21) Appl. No.: 18/534,844

(22) Filed: Dec. 11, 2023

Related U.S. Application Data
Application No. 16/948,120 is a continuation of application No. PCT/US20/45218, filed on Aug. 6, 2020.
Application No. PCT/US20/45218 is a continuation of application No. 16/948,120, filed on Sep. 3, 2020.
(60) Provisional application No. 62/883,480, filed on Aug. 6, 2019.

(51) Int. Cl. H04N 19/44; H04N 19/174; H04N 19/33; H04N 19/46

(52) U.S. Cl. CPC H04N 19/44; H04N 19/174; H04N 19/33; H04N 19/46

(57) ABSTRACT

A video encoder encodes a bitstream for decoding by a compliant decoder which is configured to selectively operate in a mode for generating a motion compensation predictor from a reference picture for a subsequent picture having a resolution different from the reference picture. The encoded bitstream includes a coded picture having a first coded region and a second coded region and signaling information from which the decoder determines first and second spatial resolution scale factors for reconstructing the first and second regions.

### CROSS-REFERENCE TO RELATED APPLICATIONS

This application is a continuation of co-pending U.S. application Ser. No. 16/948,120, filed on Sep. 3, 2020, and entitled ADAPTIVE RESOLUTION MANAGEMENT USING SUB-FRAMES, which is a continuation of International Application No. PCT/US20/45218, filed on Aug. 6, 2020 and entitled “ADAPTIVE RESOLUTION MANAGEMENT USING SUB-FRAMES,” which claims the benefit of priority of U.S. Provisional Patent Application Ser. No. 62/883,480, filed on Aug. 6, 2019, and titled “ADAPTIVE RESOLUTION MANAGEMENT USING SUB-FRAMES.” Each of which is incorporated by reference herein in its entirety.

### FIELD OF THE INVENTION

The present invention generally relates to the field of video compression. In particular, the present invention is directed to adaptive resolution management using sub-frames.

### BACKGROUND

A video codec may include an electronic circuit or software that compresses or decompresses digital video. It may convert uncompressed video to a compressed format or vice versa. In the context of video compression, a device that compresses video (and/or performs some function thereof) may typically be called an encoder, and a device that decompresses video (and/or performs some function thereof) may be called a decoder.

A format of compressed data may conform to a standard video compression specification. Compression may be lossy in that compressed video may lack some information present in an original video. A consequence of this may include that decompressed video may have lower quality than an original uncompressed video because there may be insufficient information to accurately reconstruct the original video.

There can be complex relationships between video quality, an amount of data used to represent a video (e.g., determined by a bit rate), complexity of encoding and decoding algorithms, sensitivity to data losses and errors, ease of editing, random access, end-to-end delay (e.g., latency), and the like.

Motion compensation may include an approach to predict a video frame or a portion thereof given a reference frame, such as previous and/or future frames, by accounting for motion of the camera and/or objects in the video. It may be employed in encoding and decoding of video data for video compression, for example in encoding and decoding using the Motion Picture Experts Group (MPEG)'s advanced video coding (AVC) standard (also referred to as H.264). Motion compensation may describe a picture in terms of transformation of a reference picture to a current picture. A reference picture may be previous in time when compared to a current picture and/or from the future when compared to the current picture.

### SUMMARY OF THE DISCLOSURE

In an aspect, a decoder includes circuitry configured to receive a bit stream, determine, for a first frame including a first sub-frame and a second sub-frame, a first scaling constant associated with the first sub-frame, determine a second scaling constant associated with the second sub-frame, and reconstructing pixel data of the first frame using the first scaling constant and the second scaling constant, wherein the first scaling constant and the second scaling constant characterize different values.

In another aspect, a method includes receiving a bit stream, determining, for a first frame including a first sub-frame and a second sub-frame, a first scaling constant associated with the first sub-frame, determining a second scaling constant associated with the second sub-frame, and reconstructing pixel data of the first frame using the first scaling constant and the second scaling constant, wherein the first scaling constant and the second scaling constant characterize different values.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustration of an example reference frame and example predicted frames of various resolution scales;

FIG. 2 is an illustration depicting an example reference frame, an example rescaled reference frame, and an example subsequent block prediction process;

FIG. 3 illustrates several frames and sub-frames, including sub-frames having different resolutions;

FIG. 4 is a process flow diagram illustrating an example process according to some implementations of the current subject matter;

FIG. 5 is a system block diagram illustrating an example decoder capable of decoding a bit stream according to some implementations of the current subject matter;

FIG. 6 is a process flow diagram illustrating an example process of encoding a video according to some implementations of the current subject matter;

FIG. 7 is a system block diagram illustrating an example video encoder according to some implementations of the current subject matter; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In many current state-of-the-art encoders, resolution is managed by re-coding and re-sending whole portion of the video known as group-of-pictures (GOP). This requires sending the intra-frame (I-frame) which can incur additional costs, since those frames are responsible for the bulk of the bits in the GOP.

Embodiments described in this disclosure relate to Adaptive Resolution Management (ARM), which is a technique that enables additional flexibility for a video encoder/decoder allowing bitrate savings in various use cases. In general, ARM includes performing a prediction using a reference frame of different resolution than a current frame. In current coding standards, reference frames have the same resolution as predicted frames. In ARM, a reference frame may be of a smaller or larger resolution than a frame being predicted. This approach may be used to downscale video resolution, thus reducing bitrate, or upscale video resolution, thus facilitating display characteristics of video playback.

ARM may alternatively or equivalently be referred to for the purposes of this disclosure as reference picture resampling (RPR); RPR and ARM may be used interchangeably.

Some implementations of the current subject matter may include using ARM for any number of frames, at any position within GOP, thus removing requirements for I-frame re-coding.

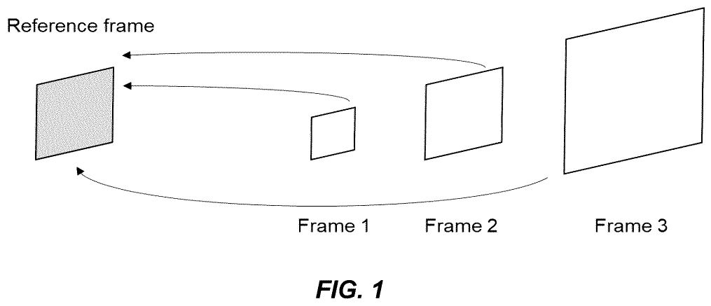

FIG. 1 is an illustration of a reference frame and predicted frames of various resolution scales. Frame 1 is smaller (lower resolution) than the reference frame, Frame 2 is of same size (same resolution), while Frame 3 is larger (greater resolution). “Resolution,” as used in this disclosure, is a number of pixels in a picture, frame, sub-frame, and/or other displayed area or portion thereof used in video playback, compression, or the like, with a higher number of pixels corresponding to a higher resolution, and a lower number of pixels corresponding to a lower resolution. Resolution may be measured in terms of area, for instance and without limitation by using one or more dimensions of length, measured in pixels that define an area. For instance, a circular sub-frame or other region may have a resolution defined according to a radius. Alternatively or additionally, resolution may be defined by an overall number of pixels.

As an example, and with continued reference to FIG. 1, where reference frame and/or subframe has a geometric form for which area may be defined entirely in terms of two length parameters, such as without limitation a triangular, parallelogram, and/or rectangular form, reference frame and/or subframe may have a resolution W×H, where W and H may indicate a number of pixels describing, respectively, width (or base) and height dimensions of reference frame and/or subframe. Each predicted frame may also have a resolution, which may be determined similarly to resolution of reference frame; for instance, frame 1 may have a smaller resolution WS×HS, frame 2 may have same resolution as reference frame W×H, and frame 3 may have larger resolution WL×HL. Width and height of smaller and larger frames may be obtained by multiplying reference width and height by an arbitrary rescaling constant (Rc), also referred to as a scaling factor and/or constant, which may alternatively or additionally be referred to with a variable name such as RefPicScale. In case of smaller frames, Rc may have a value between 0 and 1. In case of larger frames, Rc may have a value greater than 1; for instance, Rc may have a value between 1 and 4. Other values are possible. Rescaling constant may be different for one resolution dimension than another; for instance, a rescaling constant Rch may be used to rescale height, while another rescalling constant Rcw may be used to rescale width.

Still referring to FIG. 1, ARM may be implemented as a mode. In case of ARM mode activation at some point during decoding, a decoder may have already received a reference frame at a resolution W×H and may rescale a predicted frame using rescaling constant. In some implementations, an encoder may signal to decoder which rescaling constant to use, for instance as a function of a picture parameter such as pps_pic_width_in_luma_samples parameter, a pps_scaling_win_right_offset parameter, and/or a pps_scaling_win_left_offset parameter. Signaling may be performed in a sequence parameter set (SPS) corresponding to a GOP containing current picture and/or in a picture parameter set (PPS) corresponding to current picture. For instance, and without limitation, encoder may signal rescaled parameters using fields such as a pps_pic_width_in_luma_samples, pps_pic_height_in_luma_samples, pps_scaling_win_left_offset, pps_scaling_win_right_offset, pps_scaling_win_top_offset, pps_scaling_win_bottom_offset, and/or sps_num_subpics_minus1. A parameter such as pps_scaling_window_explicit_signalling_flag equal to 1 may specify that scaling window offset parameters are present in the PPS; pps_scaling_window_explicit_signalling_flag equal to 0 may indicate that the scaling window offset parameters are not present in the PPS. When sps_ref_pic_resampling_enabled_flag is equal to 0, a value of pps_scaling_window_explicit_signalling_flag may be equal to 0. pps_scaling_win_left_offset, pps_scaling_win_right_offset, pps_scaling_win_top_offset, and pps_scaling_win_bottom_offset may specify offsets that are applied to picture size for scaling ratio calculation. When not present, values of pps_scaling_win_left_offset, pps_scaling_win_right_offset, pps_scaling_win_top_offset, and pps_scaling_win_bottom_offset may be inferred to be equal to pps_conf_win_left_offset, pps_conf_win_right_offset, pps_conf_win_top_offset, and pps_conf_win_bottom_offset, respectively.

Further referring to FIG. 1, W and H parameters as described above may be represented, without limitation, using variables CurrPicScalWinWidthL and CurrPicScalWinHeightL, respectively; these variables may be derived from signaled parameters as described above using one or more mathematical relationships between the signaled parameters and the variables. For instance, and without limitation, CurrPicScalWinWidthL may be derived according to the following equation:

CurrPicScalWinWidthL=pps_pic_width_in_luma_samples−SubWidthC*(pps_scaling_win_right_offset+pps_scaling_win_left_offset)

As a further non-limiting example, CurrPicScalWinHeightL may be derived according to the following equation:

CurrPicScalWinWidthL=pps_pic_width_in_luma_samples−SubWidthC*(pps_scaling_win_right_offset+pps_scaling_win_left_offset)

Persons skilled in the art, upon reviewing the entirety of this disclosure, will be aware of various alternative computations that may be used to derive the above-described variables. Encoder may alternatively or additionally signal one or more such variables, Rc, Rch, and/or Rcw directly for instance and without limitation in a PPS and/or SPS.

Alternatively or additionally, and still referring to FIG. 1, a rescaling constant and/or set of rescaling constants as described above may be signaled in a bitstream using a reference to an index of a stored scaling constant and/or constants, and/or of a frame and/or block that was signaled using a previously signaled and/or utilized scaling constant and/or constants. Reference to index of a stored scaling constant may be signaled explicitly and/or determined from one or more additional parameters signaled in bitstream. For instance, and without limitation, decoder may identify a reference frame and/or group of pictures containing a current frame; where a rescaling constant has previously been signaled and/or used in such a group of pictures, with a reference frame signaled as applicable to current frame and/or current group of pictures, or the like, decoder may identify that rescaling constant for use as a rescaling constant with the current frame.

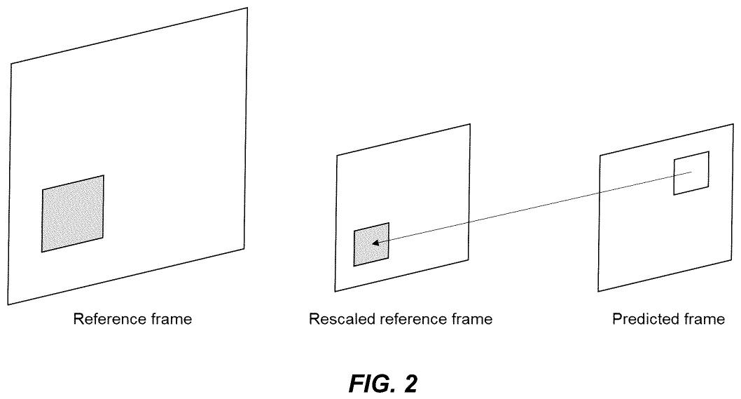

In some implementations, and with continued reference to FIG. 1, ARM operation may be executed on a block level of encoded frames. For example, a reference frame may first be rescaled and subsequently prediction may be performed, as depicted in FIG. 2. FIG. 2 is an illustration depicting a reference frame, a rescaled reference frame, and a subsequent block prediction process. Block prediction process may be performed on a scaled reference frame (having a scaled resolution) rather than the original reference frame. Rescaling reference frame may include rescaling according to any parameter signaled by an encoder as described above; for instance and without limitation, where a reference frame to be used with current picture is signaled, such as via a reference to an index value associated with reference frame or the like, the signaled reference frame may be rescaled, prior to prediction, according to any method of rescaling described above. A rescaled reference frame may be stored in memory and/or in a buffer, which may include without limitation a buffer identifying frames contained therein by indices, according to which frame retrieval may be performed; buffer may include a decoded picture buffer (DCB) and/or one or more additional buffers implemented by decoder. Prediction process may include, for example, inter picture prediction including motion compensation.

Some implementations of block-based ARM may enable flexibility in applying optimal filters for each block, instead of applying same filter for a whole frame. In some implementations, a skip-ARM mode may be possible such that some blocks (based for example on the uniformity of the pixels and bitrate cost) can be in a skip-ARM mode (such that rescaling would not change the bitrate). Skip-ARM mode may be signaled in a bitstream; for instance, and without limitation, skip-ARM mode may be signaled in a PPS parameter. Alternatively or additionally, decoder may determine that skip-ARM mode is active based on one or more parameters set by decoder and/or signaled in bitstream. Spatial filters used in block-based ARM may include, without limitation, bicubic spatial filters that apply bicubic interpolation, bilinear spatial filters that apply bi-linear interpretation, Lanczos filters that use Lanczos filtering and/or Lanczos resampling using combinations of sinc filters, sinc-function interpolation and/or signal reconstruction techniques, or the like; persons skilled in the art, upon reviewing the entirety of this disclosure, will be aware of various filters that may be used for interpolation consistently with this disclosure. Interpolation filters may include, as a non-limiting example, any filters described above, a low-pass filter, which may be used, without limitation, by way of an up-sampling process whereby pixels between pixels of block and/or frame previous to scaling may be initialized to zero, and then populated with an output of the low-pass filter. Alternatively or additionally, any luma sample interpolation filtering process may be used. Luma sample interpretation may include computation of an interpolated value at a half-sample interpolation filter index, falling between two consecutive sample values of a non-scaled sample array. Computation of interpolated value may be performed, without limitation, by retrieval of coefficients and/or weights from lookup tables; selection of lookup tables may be performed as a function of motion models of coding units and/or scaling ratio amounts, for instance as determined using scaling constants as described above. Computation may include, without limitation, performing weighted sums of adjacent pixel values, where weights are retrieved from lookup tables. Computed values may alternatively or additionally be shifted; for instance and without limitation, values may be shifted by Min(4, BitDepth −8), 6, Max(2, 14— BitDepth), or the like. Persons skilled in the art, upon reviewing the entirety of this disclosure, will be aware of various alternative or additional implementations that may be used for interpolation filters.

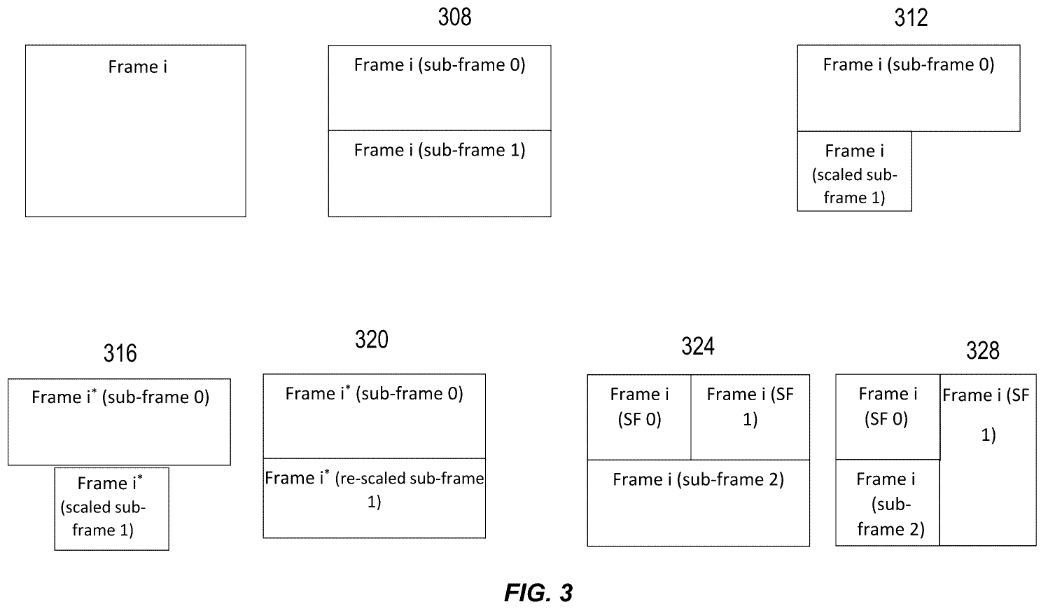

In some implementations, compression efficiency may be improved by encoding sub-frames of a video frame at a lower resolution. Sub-frames are defined for the purposes of this disclosure as regions of a frame, each of which does not include all pixels of the overall frame. Regions may include one or more blocks as described in this disclosure; one or more blocks and/or regions may have any suitable shape, including without limitation a rectangular shape. Subframes may be coded, as a non-limiting example, as tiles, slices, and/or regions of a frame. Sub-frames may include non-overlapping regions of a frame that together constitute a frame. FIG. 3 illustrates exemplary embodiments of several frames and sub-frames, including sub-frames having different resolutions.

At 304, a single frame i is illustrated. Tile number and position within frame i may be signaled in a picture header. In an embodiment, signaling may be explicit; alternatively or additionally, PPS may signal tile rows, columns, row height, and/or column width, any or all of which may be combined and/or utilized by a decoder to determine tile count and/or number. For instance, and without limitation, a PPS parameter denoted as pps_num_exp_tile_columns_minus1, with 1 added to it, may specifie a number of explicitly provided tile column widths. As a further non-limiting example, a parameter pps_tile_column_width_minus1 [i], with 1 added to it, may specify the width of the i-th tile column, for instance in units of coding tree blocks (CTBs) for i in the range of 0 to pps_num_exp_tile_columns_minus1, inclusive. A parameter pps_tile_row_height_minus1 [i] plus 1, with 1 added to it, may specify the height of the i-th tile row, for instance in units of CTBs for i. Signaled parameters may alternatively or additionally specify numbers and/or dimensions of slices within one or more tiles. For instance, a parameter denoted pps_num_exp_slices_in_tile[i] may specify a number of explicitly provided slice heights for slices in a tile containing the i-th slice. A parameter denoted pps_slice_width_in_tiles_minus1 [i], with 1 added to it, may specify a width of the i-th rectangular slice in units of tile columns. A parameter denoted pps_slice_height_in_tiles_minus1 [i], with 1 added to it, may specify a height of the i-th rectangular slice in units of tile rows, for instance when pps_num_exp_slices_in_tile[i] is equal to 0. Persons skilled in the art, upon reviewing the entirety of this disclosure, will be aware of various alternative or additional ways in which tile and/or slice parameters may be signaled and/or determined in and/or from bitstream and/or header parameters, whether implicitly or explictly.

Further referring to FIG. 3, a frame may be divided into two or more sub-frames. Sub-frames may be identified and/or signaled one or more tiles and/or slices as described above, including, without limitation, by specification of tiles and/or slices included in a given sub-frame. At 308, frame i is illustrated divided into two sub-frames, (sub-frame 0 and sub-frame 1).

In some implementations, and still referring to FIG. 3 an encoder may determine if any sub-frame should be encoded at a rescaled resolution. Sub-frames may be scaled using a rescaling constant Rc. In an embodiment, and without limitation, a horizontal scaling constant Rch may be applied in the horizontal dimension and a vertical scaling constant Rcv may be applied in the vertical dimension. Rc<1 can be used to reduce the data to be encoded and thereby reduce the bitrate of the encoded video. FIG. 3 at 312 illustrates an example where sub-frame 1 is rescaled to half-horizontal resolution (Rch=0.5). Scaling factors Rch and Rcv may be signaled to a decoder. When Rch=Rcv, only one value is signaled to the receiver.

Still referring to FIG. 3, each sub-frame (sub-frame 0 and re-scaled sub-frame 1) may then be divided into blocks and encoded using available encoding algorithms. Motion compensated transform coding may be applied to sub-frames. Encoded sub-frames may be received by a decoder for decoding. Decoded sub-frames at a receiver may be rescaled to an original resolution. A fully reconstructed frame may then be used for display purposes. FIG. 3 at 316 illustrates a non-limiting example of a decoded Frame i, Frame i*, which at a receiver may have sub-frame 0 at full resolution and sub-frame 1 at lower resolution. At 320, sub-frame 1 is illustrated for exemplary purposes as re-scaled to full resolution before it is used for display or for use as a reference frame.

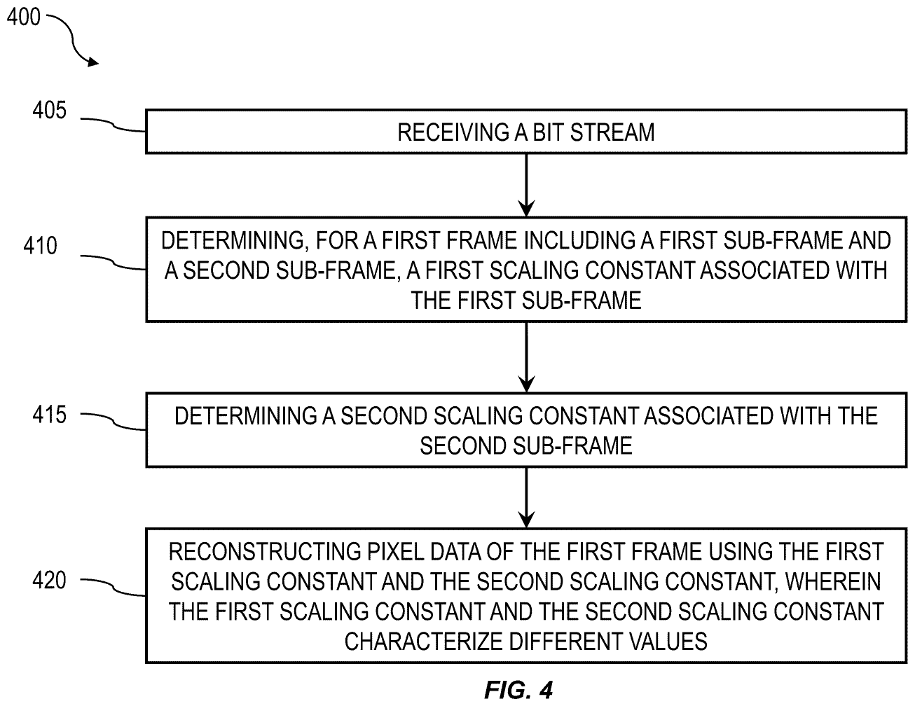

FIGS. 3 at 324 and 328 illustrate additional non-limiting examples of sub-frame configurations; for instance, and without limitation, there may be three or more sub-frames, each of which may be rescaled differently and each of which may be signaled according to any process and/or parameter for such signaling as described in this disclosure. In an embodiment, some sub-frames may increase in area, length, width, and/or other dimensions as a result of the rescaling, while others may decrease in in area, length, width, and/or other dimensions; this may, for instance, permit one part of a frame to increase in size while another part decreases in size, such that dimensions of overall frame may remain the same. Alternatively, one or more sub-frames increasing in size may overlap and/or occlude one or more other sub-frames. Spatial resolution may change in a sequence and in that case only a region of previously coded frames may be in the current frame. FIG. 4 is a process flow diagram illustrating an example process 400 of adaptive resolution management that may enable additional flexibility for a video encoder and/or decoder allowing bitrate savings in various use cases.

At step 405, and still referring to FIG. 4, a bit stream is received by a decoder. A current block may be contained within a bit stream that decoder receives. Bit stream may include, for example, data found in a stream of bits that is the input to a decoder when using data compression. Bit stream may include information necessary to decode a video. Receiving may include extracting and/or parsing a block and associated signaling information from bit stream. In some implementations, a current block may include a slice, a tile, coding tree unit (CTU), a coding unit (CU), a prediction unit (PU) and/or any other portion of a frame and/or picture, for instance and without limitation as described in further detail below.

At step 410, and with continuing reference to FIG. 4, a first scaling constant associated with a first sub-frame may be determined for a first frame including a first sub-frame and a second sub-frame. In some implementations, a first scaling constant may include a vertical scaling component and a horizontal scaling component. A first scaling constant may be signaled within bit stream and a second scaling constant may be signaled within bit stream. In some implementations, first scaling constant may be signaled in bit stream as an index to a predetermined value.

At step 415, and further referring to FIG. 4, a second scaling constant associated with a second sub-frame may be determined; this may be implemented in any manner suitable for determination of first scaling constant for first sub-frame as described above.

At step 420, and still referring to FIG. 4, pixel data of the first frame may be reconstructed using first scaling constant and second scaling constant. First scaling constant and second scaling constant may characterize different values. In some implementations, reconstructing pixel data of first frame includes reconstructing pixel data of first sub-frame and reconstructing pixel data of the second sub-frame.

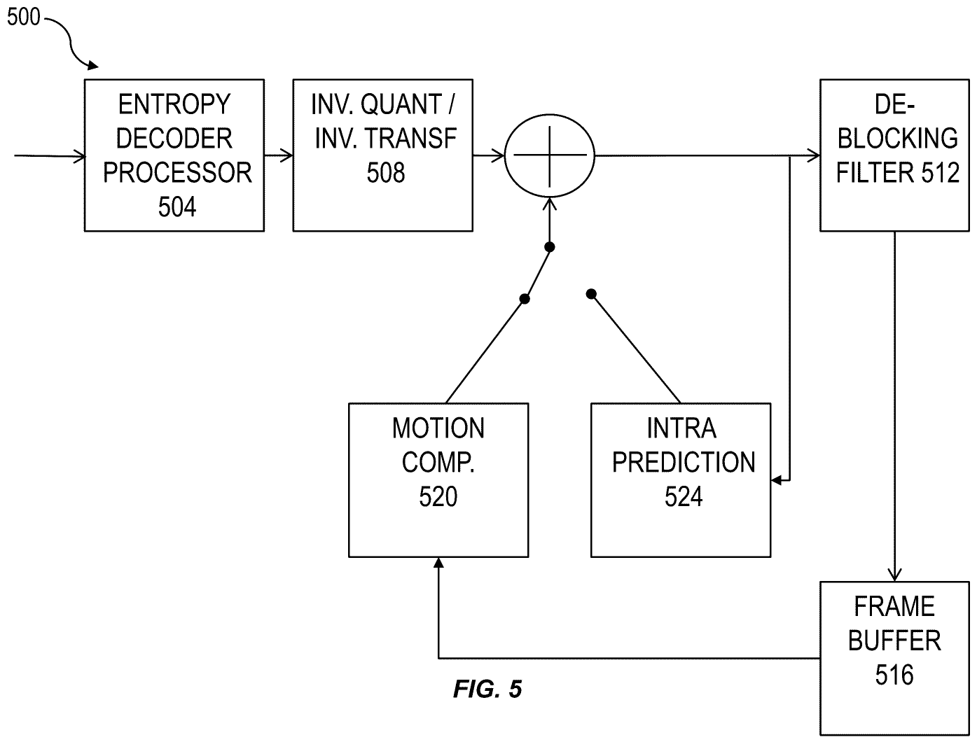

FIG. 5 is a system block diagram illustrating an example decoder 500 capable of decoding a bitstream with merge candidate reorder based on global motion vector. Decoder 500 may include an entropy decoder processor 504, an inverse quantization and inverse transformation processor 508, a deblocking filter 512, a frame buffer 516, a motion compensation processor 520 and/or an intra prediction processor 524.

In operation, and still referring to FIG. 5, bit stream 528 may be received by decoder 500 and input to entropy decoder processor 504, which may entropy decode portions of bit stream into quantized coefficients. Quantized coefficients may be provided to inverse quantization and inverse transformation processor 508, which may perform inverse quantization and inverse transformation to create a residual signal, which may be added to an output of motion compensation processor 520 or intra prediction processor 524 according to a processing mode. An output of the motion compensation processor 520 and intra prediction processor 524 may include a block prediction based on a previously decoded block. A sum of prediction and residual may be processed by deblocking filter 512 and stored in a frame buffer 516.

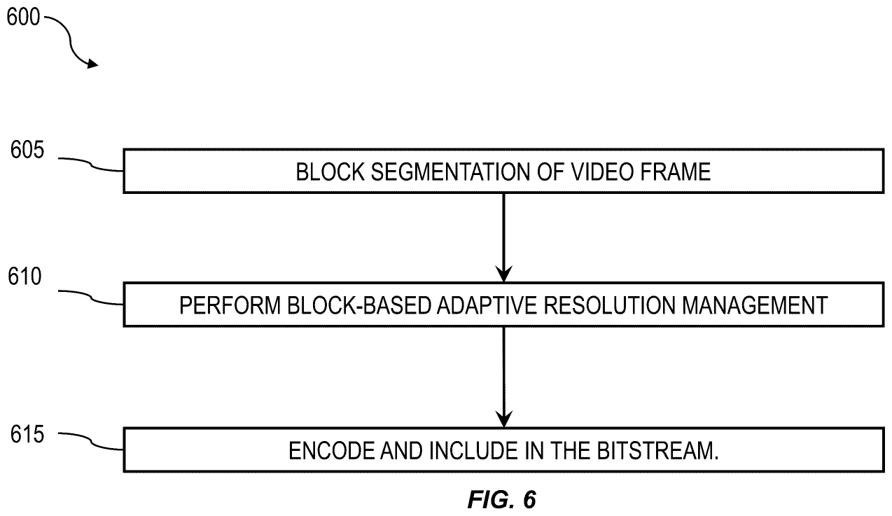

FIG. 6 is a process flow diagram illustrating an exemplary embodiment of a process 600 of encoding a video with adaptive resolution management that may enable additional flexibility for a video encoder and/or decoder allowing bitrate savings in various use cases. At step 605, a video frame may undergo initial block segmentation, for example, using atree-structured macro block partitioning scheme that may include partitioning a picture frame into CTUs and/or CUs.

At step 610, and still referring to FIG. 6, block-based adaptive resolution management may be performed, including resolution scaling of a frame or portion thereof, for instance and without limitation as described above.

At step 615, and further referring to FIG. 6, a block may be encoded and included in a bit stream. Encoding may include utilizing inter prediction and intra prediction modes, for example.

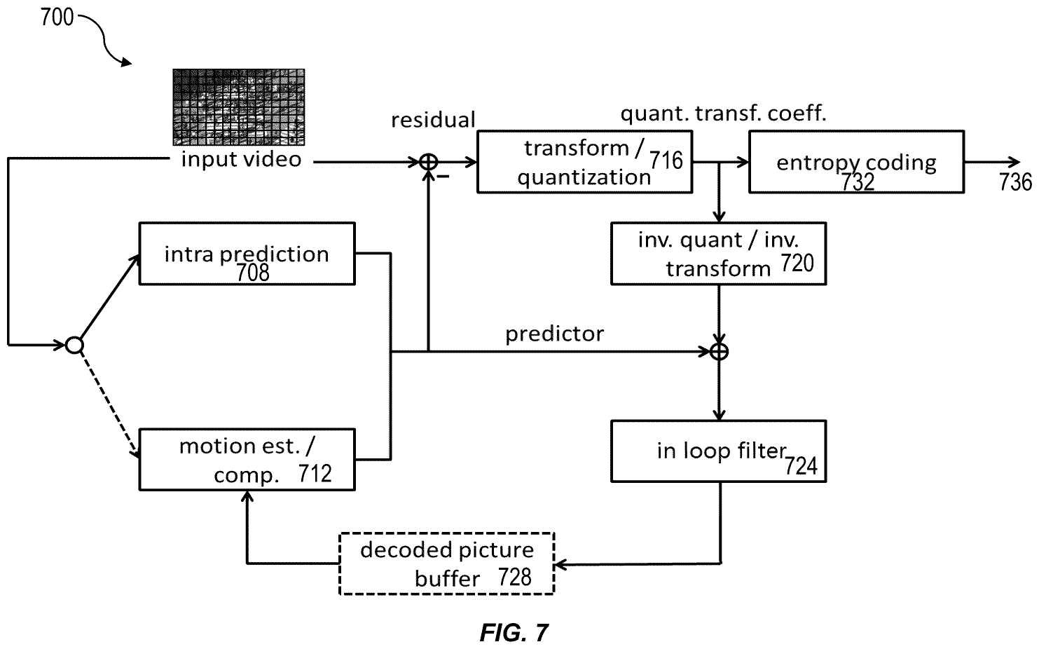

FIG. 7 is a system block diagram illustrating an example video encoder 700 capable of encoding a video with merge candidate reorder based on global motion vector. Example video encoder 700 may receive an input video 704, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 7, example video encoder 700 may include an intra prediction processor 708, a motion estimation/compensation processor 712, which may also be referred to as an inter prediction processor, capable of constructing a motion vector candidate list including adding a global motion vector candidate to the motion vector candidate list, a transform/quantization processor 716, an inverse quantization/inverse transform processor 720, an in-loop filter 724, a decoded picture buffer 728, and/or an entropy coding processor 732. Bit stream parameters may be input to the entropy coding processor 732 for inclusion in the output bit stream 736.

In operation, and with continued reference to FIG. 7, for each block of a frame of input video 704, whether to process block via intra picture prediction or using motion estimation/compensation may be determined. Block may be provided to intra prediction processor 708 or motion estimation/compensation processor 712. If block is to be processed via intra prediction, intra prediction processor 708 may perform processing to output a predictor. If block is to be processed via motion estimation/compensation, motion estimation/compensation processor 712 may perform processing including constructing a motion vector candidate list including adding a global motion vector candidate to the motion vector candidate list, if applicable.

Further referring to FIG. 7, a residual may be formed by subtracting a predictor from input video. Residual may be received by transform/quantization processor 716, which may perform transformation processing (e.g., discrete cosine transform (DCT)) to produce coefficients, which may be quantized. Quantized coefficients and any associated signaling information may be provided to entropy coding processor 732 for entropy encoding and inclusion in output bit stream 736. Entropy encoding processor 732 may support encoding of signaling information related to encoding a current block. In addition, quantized coefficients may be provided to inverse quantization/inverse transformation processor 720, which may reproduce pixels, which may be combined with a predictor and processed by in loop filter 724, an output of which may be stored in decoded picture buffer 728 for use by motion estimation/compensation processor 712 that is capable of constructing a motion vector candidate list including adding a global motion vector candidate to the motion vector candidate list.

With continued reference to FIG. 7, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 7, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 7, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Embodiments disclosed herein may include a decoder having circuitry configured to receive a bit stream, determine, for a first frame including a first sub-frame and a second sub-frame, a first scaling constant associated with the first sub-frame, determine a second scaling constant associated with the second sub-frame, and reconstruct pixel data of the first frame using the first scaling constant and the second scaling constant, wherein the first scaling constant and the second scaling constant characterize different values.

In some embodiments, the first scaling constant may include a vertical scaling component and a horizontal scaling component. Reconstructing the pixel data of the first frame may include reconstructing pixel data of the first sub-frame and reconstructing pixel data of the second frame. The first scaling constant may be signaled within the bit stream and the second scaling constant is signaled within the bit stream. The first scaling constant may be signaled in the bit stream as an index to a predetermined value. The second scaling constant may be signaled in the bit stream using at least a picture parameter. The first scaling constant may be signaled in a picture parameter set (PPS). The first scaling constant may be signaled as a function of a pps_pic_width_in_luma_samples parameter, a pps_scaling_win_right_offset parameter, and a pps_scaling_win_left_offset parameter. A position of the first sub-frame within the first frame may be signaled in a PPS. The decoder may include an entropy decoder processor configured to receive the bit stream and decode the bit stream into quantized coefficients, an inverse quantization and inverse transformation processor configured to process the quantized coefficients including performing an inverse discrete cosine, a deblocking filter, a frame buffer, and an intra prediction processor.

In embodiments disclosed herein, a method may include receiving a bit stream, determining, for a first frame including a first sub-frame and a second sub-frame, a first scaling constant associated with the first sub-frame, determining a second scaling constant associated with the second sub-frame, and reconstructing pixel data of the first frame using the first scaling constant and the second scaling constant, wherein the first scaling constant and the second scaling constant characterize different values.

In some embodiments, the first scaling constant may include a vertical scaling component and a horizontal scaling component. Reconstructing the pixel data of the first frame may include reconstructing pixel data of the first sub-frame and reconstructing pixel data of the second frame. The first scaling constant may be signaled within the bit stream and the second scaling constant is signaled within the bit stream. The first scaling constant may be signaled in the bit stream as an index to a predetermined value. The second scaling constant may be signaled in the bit stream using at least a picture parameter. The first scaling constant may be signaled in a picture parameter set (PPS). The first scaling constant may be signaled as a function of a pps_pic_width_in_luma_samples parameter, a pps_scaling_win_right_offset parameter, and a pps_scaling_win_left_offset parameter. A position of the first sub-frame within the first frame may be signaled in a PPS. At least one of the receiving, the determining, and the reconstructing is performed by a decoder that includes an entropy decoder processor configured to receive the bit stream and decode the bit stream into quantized coefficients, an inverse quantization and inverse transformation processor configured to process the quantized coefficients including performing an inverse discrete cosine, a deblocking filter, a frame buffer, and an intra prediction processor.

It is to be noted that any one or more of the aspects and embodiments described herein may be conveniently implemented using digital electronic circuitry, integrated circuitry, specially designed application specific integrated circuits (ASICs), field programmable gate arrays (FPGAs) computer hardware, firmware, software, and/or combinations thereof, as realized and/or implemented in one or more machines (e.g., one or more computing devices that are utilized as a user computing device for an electronic document, one or more server devices, such as a document server, etc.) programmed according to the teachings of the present specification, as will be apparent to those of ordinary skill in the computer art. These various aspects or features may include implementation in one or more computer programs and/or software that are executable and/or interpretable on a programmable system including at least one programmable processor, which may be special or general purpose, coupled to receive data and instructions from, and to transmit data and instructions to, a storage system, at least one input device, and at least one output device. Appropriate software coding may readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, Programmable Logic Devices (PLDs), and/or any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

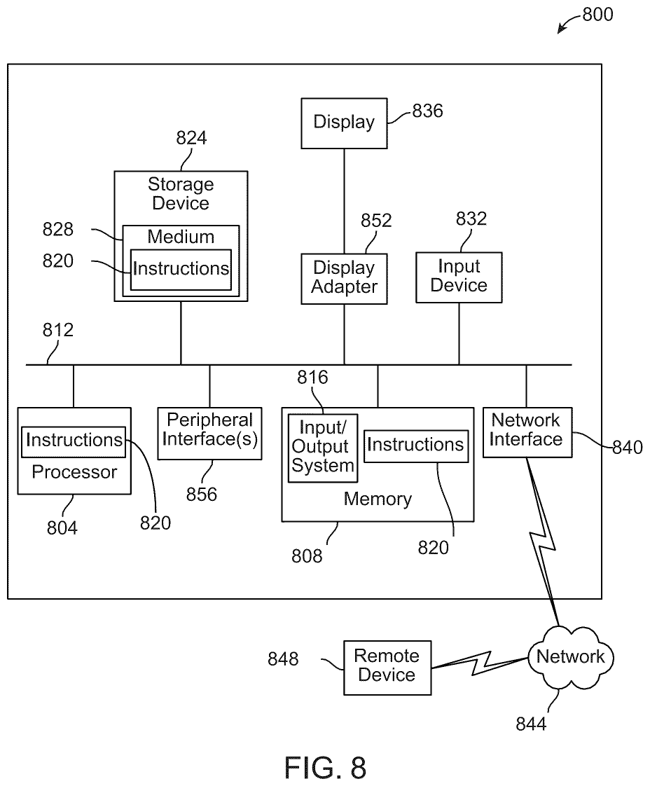

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments as disclosed herein. Accordingly, this description is meant to be taken only by way of example, and not to otherwise limit the scope of this invention.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A video encoder configured to:
encode a bitstream to be decoded by a decoder, the decoder being configured to:
selectively operate in a mode for generating a motion compensation predictor from a reference picture for a subsequent picture having a resolution different from the reference picture, the mode utilizing a spatial resolution changing scale factor and a filter;
receive a bit stream including a coded picture and signaling information, the coded picture including a first coded region and second coded region, the signaling information including first information for determining a first spatial resolution changing scale factor and second information useful for determining a second spatial resolution changing scale factor;
determine, using the first information, the first spatial resolution changing scale factor, the first scale factor being associated with the first region;
determine using the second information, the second spatial resolution changing scale factor, the second scale factor being associated with the second region, the first and second scale factors having different values; and
reconstruct the pixel values of the coded picture using the mode with the first spatial resolution changing scale factor to form a first motion compensation predictor to decode the first region and using the mode with the second spatial resolution changing scale factor to form a second motion compensation predictor to decode the second region.

2. The encoder of claim 1 wherein the first region is a first slice of the picture and the second region is a second slice of the picture.

3. The encoder of claim 1 wherein the first region is a first sub-picture and the second region is a second sub-picture.

4. The encoder of claim 1 wherein the first region and the second region comprise the entire picture.

5. The encoder of claim 1 wherein the first and second scale factors are both horizontal scale factors.

6. The encoder of claim 1 wherein the first and second scale factors are both vertical scale factors.

7. The encoder of claim 1 wherein the first region includes a first coding unit and the second region includes a second coding unit.

8. The encoder of claim 7 wherein the first coding unit is N×N and N is one of 16, 32, 64, 128, and the second coding unit is M×M and M is one of 16, 32, 64, 128.
